(19) United States
(12) Patent Application Publication
(10) Pub. No.: US 2002/0128885 A1
(43) Pub. Date: Sep. 12, 2002

(54) Method and system for characterization and matching of attributes and requirements

(76) Inventor: Robert E. Evans, Phoenix, AZ (US)

Correspondence Address: @ PatentPlanet, 1173 St. Charles Court, Los Altos, CA, 94024, US

(21) Appl. No.: 09/756,311

(22) Filed: Jan. 6, 2001

(51) Int. Cl. G06F 17/60

(52) U.S. Cl. 705/7

(57) ABSTRACT

The present invention relates to search technology involving classification and matching of attributes and requirements. It is applicable to classifying and matching any type of knowledge, skills, know-how, services, materials, equipment, or other data where the matching of attributes and/or requirements is useful to an entity such as a person or organization. The present invention enables matching the candidates with requirements on a worldwide scale. Also, the present invention can identify which candidate possesses certain useful characteristics, properties, skills, know-how, and capabilities. Concepts such as the types of services or industries served, to be searched can be represented with numeric codes. Users preferably only see menus in their own language. The hierarchical structure conveys the relationship between concepts (from the very general to the very specific). It provides grading of “near-hits” while eliminating irrelevant matches in the searching process.

### BACKGROUND

The present invention relates to search technology that facilitates characterization and matching of attributes and requirements.

The high transaction costs in the engineering and construction industry motivated the development of the present invention. One cost relates to finding firms and individuals in a highly fragmented industry that are qualified to do a particular project. A recent study estimated in 1999 that there were over 72,000 firms offering engineering/design services in North America, and more than 260,000 in the world. Further, only a few well-known engineering/design services firms existed, and the top 100 firms held only about 7% of the market in North America. Consequently, the buyers are faced with considerable expense in identifying qualified firms, other than the relatively few firms each buyer already knows and has done business with in the past.

Yet it has been estimated that half of all engineering and construction projects overrun their original schedule; and a one-day gain in schedule often equals millions of dollars of revenue for the buyer. Thus, it is difficult to identify the most qualified firm, and the consequences of not selecting one can be dire. On the engineering/design firm side, it is becoming cost prohibitive to seek opportunities outside a known set of clients. If a project hits a financial snag, the firm may not get fairly compensated. Thus, there is an incentive to work with only existing clients. Further, the same study estimated that profit margins for engineering/design firms have continued on an almost steady decline since 1980. In 1998, of the top 100 firms, only four had earnings in excess of 5% of revenues and some of the largest firms exited the industry entirely.

In many industries, a person, organization and other entity may be unable to rapidly identify the candidates that have the skills, know-how, and capabilities related to certain requirements. Larger firms can have problems keeping track of even their own people, because of scale, geographic separation, turnover and the fact that individual know-how, skills, and capabilities change. Separately, entities can have problems identifying and matching things other than people, but nevertheless termed candidates, such as equipment, parts, material, chemicals, information and other data having certain properties, characteristics and attributes. There needs to be an efficient way for individuals and organizations to gather, organize, update, and disseminate the attributes of “candidates” that can meet requirements. There also needs to be a way to provide rapid updates and access to persons or things with attributes that relate to an existing problem or a new business opportunity.

These problems motivated me to enable, for example, a searcher, a planner, a buyer, a recruiter to quickly find qualified candidates from a much larger base than those presently known, and to enable candidates, sellers and providers to reach the global marketplace at a fraction of current costs. I realized the need to characterize attributes (e.g., skills, know-how, and capabilities possessed) of candidates, and characterize requirements (e.g., skills, know-how, and capabilities needed) of searchers, planners, and buyers, etc. The technique would preferably eliminate irrelevant “matches” and not exclude “near matches,” provide for grading of hits, and show the basis of the grading by viewing the score of each attribute and/or requirement if desired to help the searcher, planner, or buyer evaluate the candidates. Both the characterization and the search would be independent of language to facilitate global commerce. The technique would be able to if desired leverage the Internet and/or World Wide Web (Web) as an enabling technology to reach worldwide, and yet be also used locally and seamlessly if desired in an organization's Intranet.

### THE SUMMARY OF INVENTION

The present invention relates to search technology that can characterize and match attributes and requirements. In one embodiment, the present invention relates to a computer-implemented method of characterizing attributes of a candidate in data independent of language, including providing an interface to enable a user to describe attributes by selecting from an hierarchical structure, associating a numeric code with each attribute, and arranging the numeric code for each attribute selected by the user, building an attributes profile, and repeating the above steps for other candidates.

In another embodiment, the present invention relates to a computer-implemented method of characterizing a searcher's requirements in terms of the candidates' attributes, including providing an interface to enable the searcher to select and specify the importance of each requirement, associating a numeric code with each requirement, and recording the numeric code and associated importance for each requirement selected by the searcher, building a requirements profile.

In another embodiment, the present invention relates to a computer-implemented method of characterizing a planner's requirements in terms of the candidates' attributes, including providing an interface to enable the planner to describe their requirements by selecting from an hierarchical structure and specifying the importance of each requirement, associating a numeric code with each requirement, and arranging the numeric code for each requirement and associated importance for each requirement selected by the planner in a requirements profile, and repeating the above steps for other planners.

In another embodiment, the present invention relates to a computer-implemented method of enabling a searcher to characterize attributes, including providing an interface to enable the searcher to select each attribute, associating a numeric code with each attribute, and recording the numeric code for each attribute selected by the searcher, building an attributes profile.

In still another embodiment, the present invention relates to a system, including a server providing a user interface for entering candidates' attributes profiles, a server providing a user interface for entering a searcher's requirements profile, a coding module to associate a numeric code with each attribute and requirement, numeric codes representing the attributes profile and the requirements profile, a data query engine to compare the requirements profile against the attributes profiles and to provide a list of candidates that have attributes that relate to the requirements, and a module to rank the list of candidates based on the degree of match between the candidates' attributes profiles and the searcher's requirements profile.

### BRIEF DESCRIPTION OF THE DRAWINGS

FIG. 1 illustrates a system for matching a searcher's requirements against candidates' attributes.

FIG. 2A illustrates English-based linked menus for entering candidate attributes and searcher requirements.

FIG. 2B illustrates Spanish-based linked menus for entering candidate attributes and searcher requirements.

FIG. 3 illustrates an alternative user interface for entry of attributes and requirements.

FIG. 4 illustrates comparing a searcher's requirements profile against a set of candidates' attributes profiles.

FIG. 5 illustrates a presentation of the degree of match between two candidates' attributes and the searcher's requirements.

FIG. 6 illustrates a portion of the hierarchical coding structure of numeric codes that define relevancy between attributes and requirements.

FIG. 7 illustrates an extension of the system to include matching attributes specified by a searcher against planners' requirements.

### DETAILED DESCRIPTION OF THE PREFERRED EMBODIMENTS

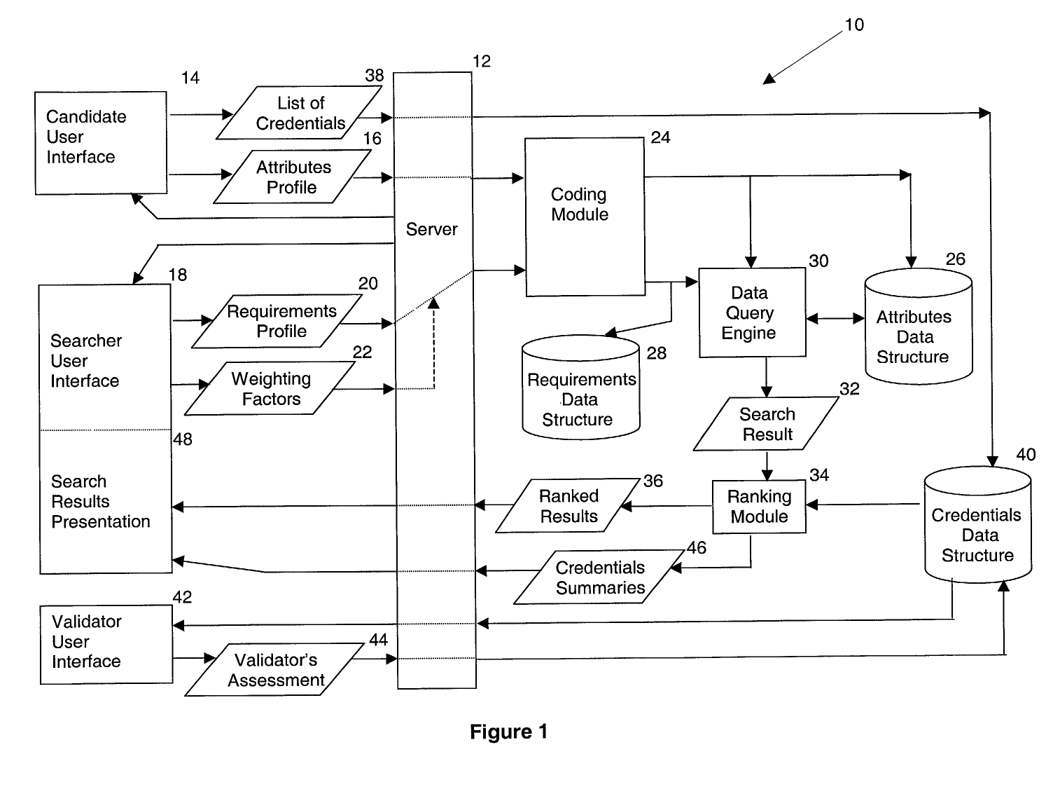

FIG. 1 illustrates a system for matching a searcher's requirements against one or more candidates' attributes. In one embodiment, the system 10 includes a server 12, with a Web server, and provides a user interface 14, running in a client browser in a computer, to enter each candidate's attributes profile 16. The server-side components of the system 10 may be written in Java and/or C++, and preferably run on the Solaris operating system in parallel in suitable Intel Pentium processors. The client-side components may be written in HTML, XML, JavaScript, Java, etc. It should be clear, however, that the invention is not limited to the Web environment, these languages, this hardware, and this operating system. Many other environments, languages, hardware, and operating systems can be used. One of ordinary skill would also understand that the system 10 could be implemented in a single computer, or another suitable client-server system communicating with or without a computer network.

Server 12 also provides a user interface 18 for entering a searcher's requirements profile 20, including the weight of each requirement, collectively known as weighting factors 22 to indicate the importance of each requirement to the searcher. A coding module 24 associates a numeric code with each requirement and attribute. The numeric code can be represented by a string of digits in which the position of each digit conveys its base weight. The numeric value of each code is the sum of the products of each digit and their base weights. For the purposes of illustration, the numeric codes shown here are in base-10 (i.e. each position weight is a power of 10). It should be clear, however, that the invention is not limited to base-10 representations and could be based on other bases such as binary, octal, hexadecimal, etc. In one embodiment, a requirements data structure 28 contains the numeric codes representing the searcher's requirements profile 20. In another embodiment, an attributes data structure 26 contains the numeric codes representing the candidate's attributes profile 16. A data query engine 30 compares the searcher's requirements profile 20 against the candidates' attributes profiles 16 and provides a search result 32, that is, a list of candidates that have attributes that relate to the searcher's requirements. A ranking module 34 provides ranked results 36, which rank the candidates based on the degree of match between each of the candidate's attributes profile and the searcher's requirements profile.

FIG. 1 also shows that server 12 provides the interface 14 to enable a candidate to enter a list of credentials 38. The server 12 writes the list of credentials 38 into a credentials data structure 40. The server 12 also provides an interface 42 to enable a validator to review the list of credentials 38 and submit an assessment 44 to the credentials data structure 40. The server 12 also provides search results presentation 48 to the searcher, including the ranked results 36 and the credentials summaries 46.

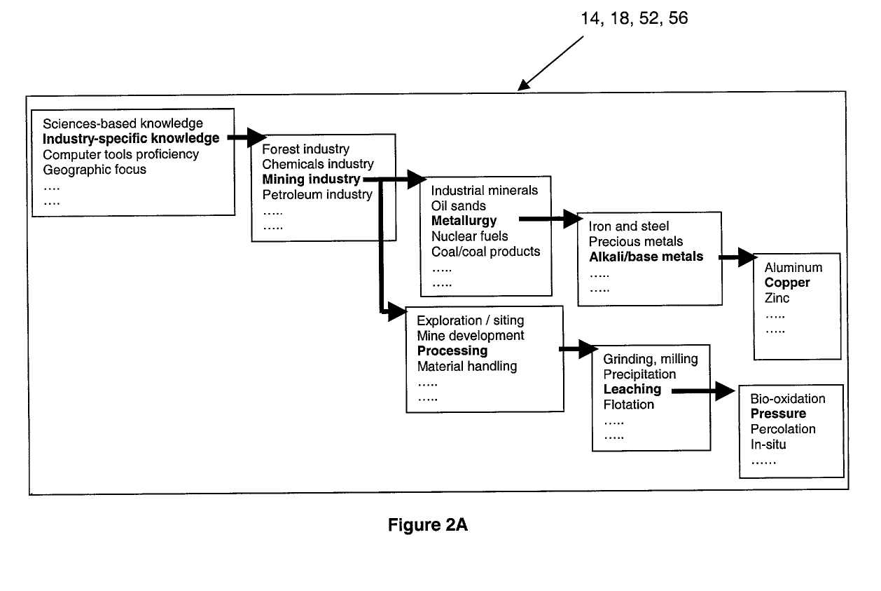

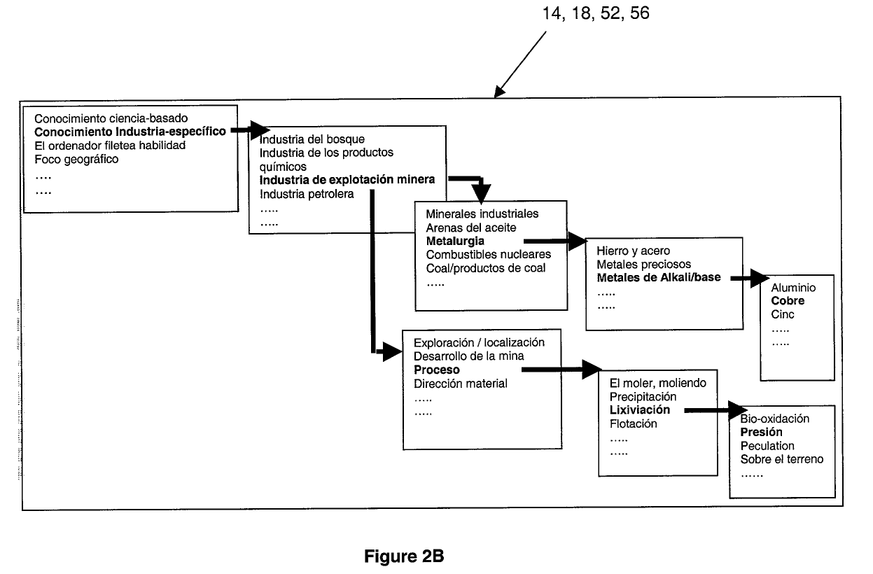

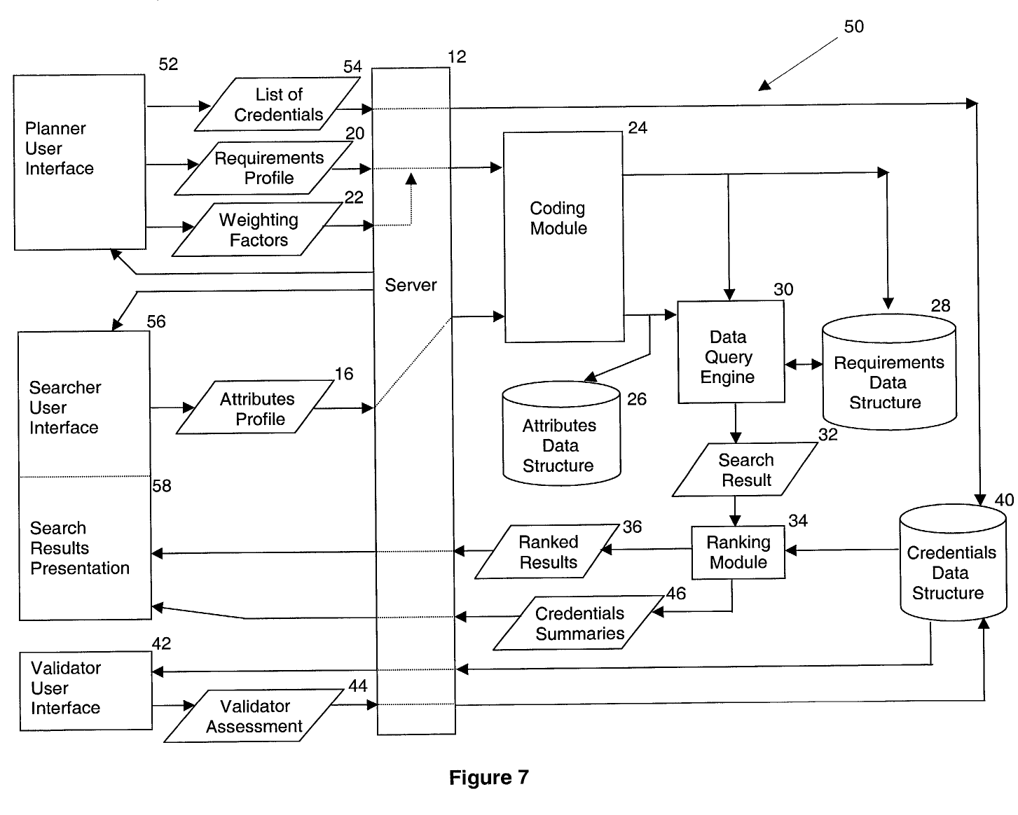

FIG. 2A illustrates one embodiment of the user interface, which can be used for the candidate user interface 14 and the searcher user interface 18 shown in FIG. 1, and for the planner user interface 52 and searcher user interface 56 shown in FIG. 7. The user interface shown in FIG. 2A employs English-based linked menus for entering attributes and requirements. The user interface presents the menu in a computer display from which the user can select from a high level list of possible occupations, skills, or knowledge areas. In this example, the user selects industry-specific knowledge, which leads to a lower level list of industries such as forest, chemicals, mining, and petroleum. The user selects mining industry, which leads to two lists. The first list divides the industry into sectors, such as industrial minerals, oil sands, metallurgy, nuclear fuels, and coal/coal products. The second list subdivides the industry into types of operation, such as exploration/siting, mine development, processing, and material handling. In the example, the user selects the metallurgy sector and processing. The metallurgy selection leads to another list of types of end products, such as iron and steel, precious metals, and alkali/base metals. The processing selection leads to another list of types of processes, such as grinding/milling, precipitation, leaching, and flotation. The alkali/base metals selection leads to a list of specific metals, such as aluminum, copper, and zinc. The leaching selection leads to a list of specific forms of leaching, such as bio-oxidation, pressure, percolation, and in-situ. In the illustration in FIG. 2A, an English-speaking user has indicated know-how in the metallurgical extraction of copper and pressure leaching processes, both specific to the mining industry.

FIG. 2B illustrates an embodiment of a user interface, which presents the equivalent information shown in FIG. 2A with Spanish-based menus for entering in attributes and requirements. In the illustration in FIG. 2B, a Spanish-speaking user has also indicated know-how in the metallurgical extraction of copper and pressure leaching processes, both specific to the mining industry.

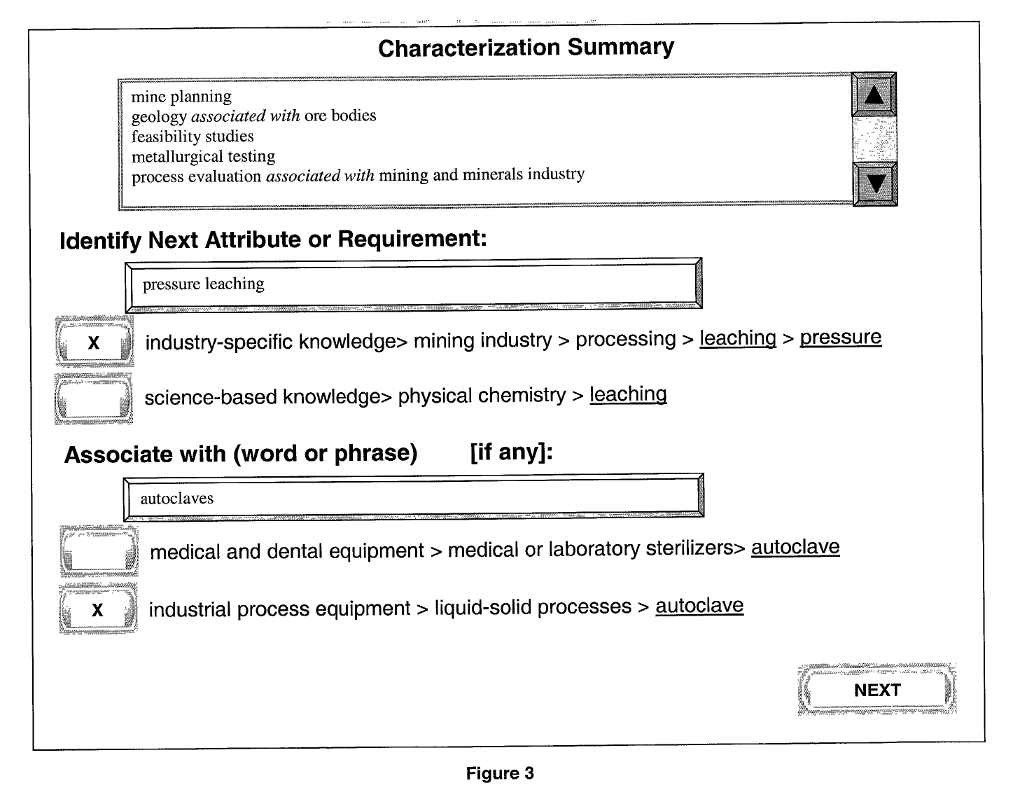

FIG. 3 illustrates one embodiment of the user interface, which can be used for the candidate user interface 14 and the searcher user interface 18 as shown in FIG. 1, and for the planner user interface 52 and searcher user interface 56 as shown in FIG. 7. The user interface presents a set of text entry fields in a computer display in which the user can indicate attributes or requirements. For each knowledge category entered by the user in the text field, the interface will display the hierarchy lineage of that category. In this example, a user entered pressure leaching, which led to two branches: one in industry-specific knowledge and another in science-based knowledge shown in the middle of the display in two lineage strings. In the example, the user checks industry-specific knowledge branch rather than science-based knowledge branch, which triggers the interface to generate an association text field to further refine the attribute or requirement. Also in the example, the user has entered the term autoclaves in the association text field, which leads to two branches: one in medical and dental equipment and another in industrial process equipment. In the example, the user checks the industrial process equipment. By selecting the next button at the bottom right of the display, the text entry fields are cleared and the attribute or requirement chosen: pressure leaching associated with autoclaves is added to the characterization summary at the top of the display.

FIGS. 2A-2B and 3 illustrate embodiments of the user interface that can be used for the candidate user interface 14 and the searcher user interface 18 shown in FIG. 1, and for the planner user interface 52 and searcher user interface 56 shown in FIG. 7. It should be clear, however, that the invention is not limited to these specific embodiments. One of ordinary skill would understand that any suitable interface that enables one to specify attributes and requirements could accomplish the same functions.

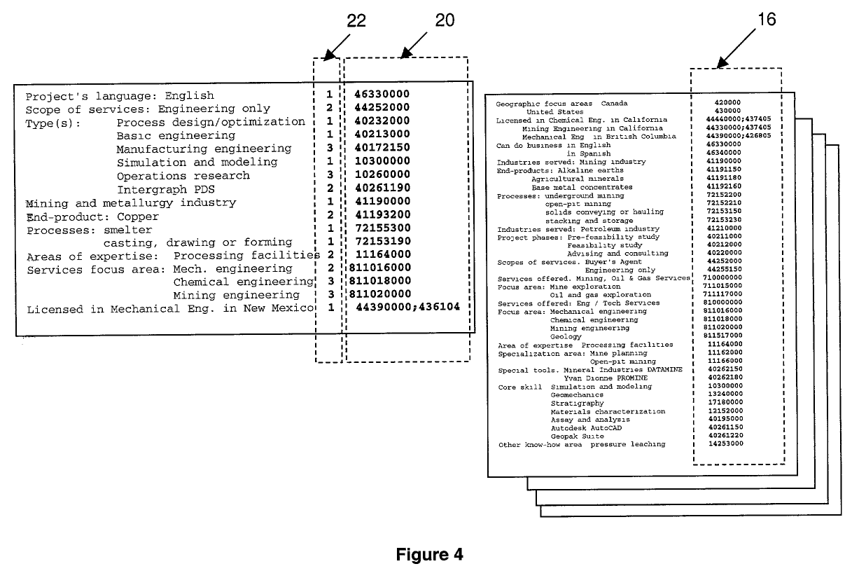

FIG. 4 illustrates how the data query engine 30 (FIG. 1) compares a searcher's requirements profile 20, together with the weighting factors 22, against one of a set of attribute profiles 16. For illustration purposes, FIG. 4 shows text and the corresponding numeric codes of the requirements profile 20 and the attributes profile 16, but the profiles preferably include only numeric codes to reduce storage requirements. Also, the weighting factors are not limited to integer values. One of ordinary skill would understand that any numerical representation for relative weighting would accomplish the same purpose.

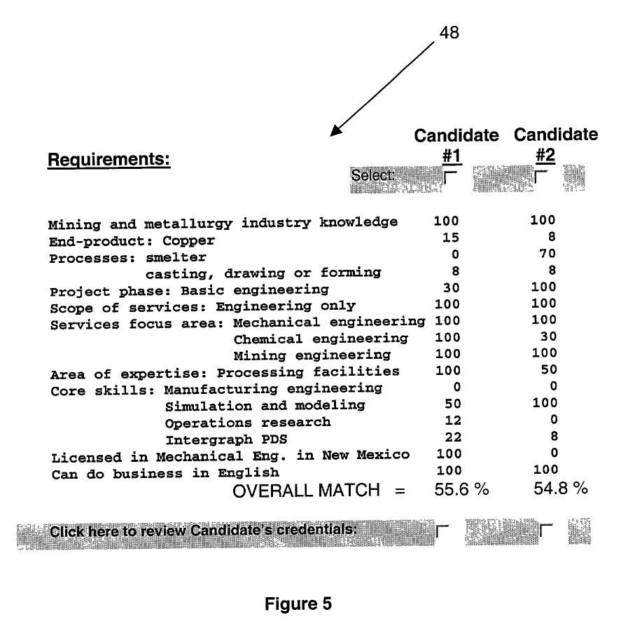

FIG. 5 illustrates how the system can compare a set of candidates' attributes profiles with a searcher's requirements profile and quantifies the degree of match. In this example, the search results presentation 48 displays two engineering firms, candidate #1 and candidate #2, which might be employed for a copper smelter project. Candidate #1 has a greater degree of overall match than candidate #2, but candidate #2 may be better qualified because candidate #1 has no capabilities specifically in smelter processes as shown by the zero on line 3, which could be essential to the project.

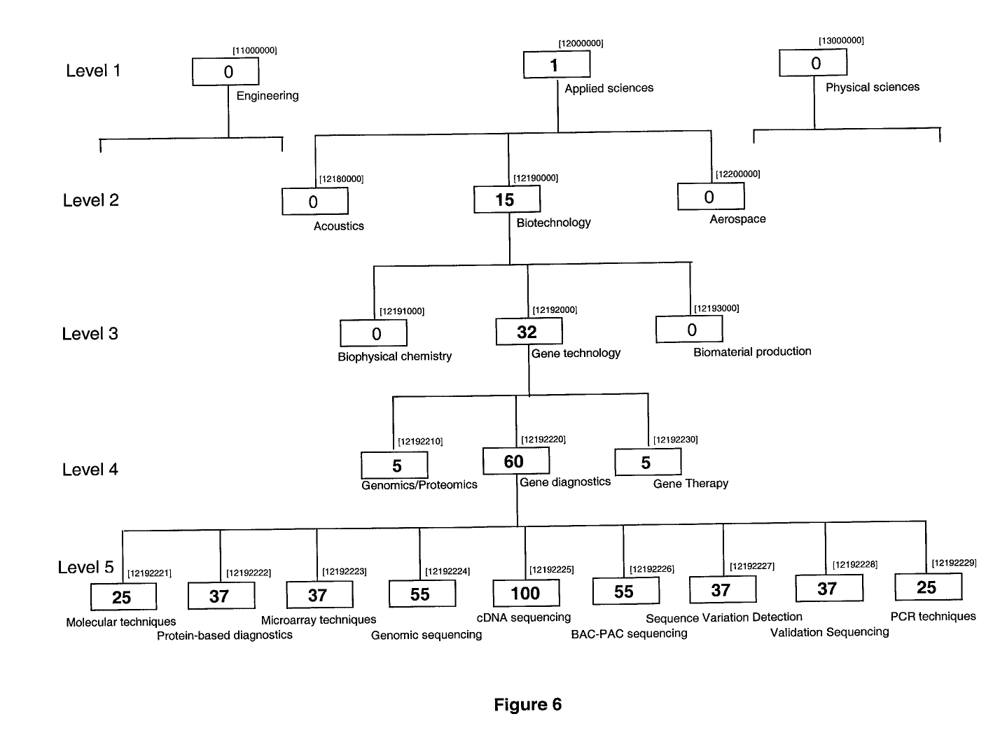

FIG. 6 illustrates how knowledge classifications can be represented as a hierarchy in the coding module 24 as shown in FIGS. 1 and 7. For purpose of illustration, we can assume that the hierarchy consists of five levels, with level 1 representing the most general descriptions of knowledge, and successively working to greater levels of detail in levels 2 through 5. Also, to illustrate the hierarchy I will focus on how the search results can employ the fact that knowledge areas are increasingly related to each other as we go to lower levels in the hierarchy. The broadest level shown as level 1 illustrates just three categories: engineering, applied sciences, and physical sciences. Even applied sciences cover many categories of knowledge, so we can further divide it into more categories such as acoustics, biotechnology, and aerospace. Going to level 3, we see biotechnology again includes many categories such as biophysical chemistry, gene technology, and biomaterial production. Going to level 4, gene technology includes categories such as genomics/proteomics, gene diagnostics, and gene therapy. Finally, level 5 illustrates a number of categories such as genomic sequencing, cDNA sequencing, and BAC-PAC sequencing, all subdivisions of gene diagnostics.

The relevancy is represented by the assignment of relevance values to each category within the hierarchy. In the illustration, a searcher looking for cDNA sequencing capability would have a 100% match if the candidate submitted capability in cDNA sequencing, and 55% match if the candidate submitted capability in the related genomic sequencing, but only 5% if the candidate had capability in the broader field of genomics only. Thus, the hierarchy not the lexical similarity between words conveys relevance between the knowledge categories. It should be clear that the relevance values used in FIG. 6 are for illustration only. One of ordinary skill would understand that any set of relevance values that conveys the relationship between one concept and another could accomplish the same function.

FIG. 6 also shows that each category has an associated numeric code. A numeric code can be represented by a suitable string of digits. For example, the numeric code can use the positional number system in which the position of each digit conveys its base weight. The numeric value of each code is the sum of the products of each digit and their base weights. For the purposes of illustration, the numeric codes shown are in base-10 (i.e. each position weight is a power of 10), but could use other bases as mentioned earlier.

For example, cDNA sequencing has the numeric code [12192225]. For purposes of this illustration, each numeric code is a five-level number, symbolized by [L1 L2 L3 L4 L5], used to represent some attribute or requirement. Each level has a numerical value, in either one or two digits. The composite of the digits for each of the five levels is the numeric code. It should be clear, however, that the invention is not limited to numeric codes having five levels or having only one or two digits represent each level. One of ordinary skill would understand that any multi-level hierarchy would accomplish the same purpose.

A numeric code's lineage is the set of numeric codes and labels within the sequence from the specific code up the highest level to which it belongs. For example, the lineage of code [12192225], which parses into the following level values: L1=12; L2=19; L3=2; L4=22; L5=5, is as follows:

| Level | Category (in English labels) | Code |
|---|---|---|
| 1 | Applied sciences | [12000000] |
| 2 | Biotechnology | [12190000] |
| 3 | Gene technology | [12192000] |
| 4 | Gene diagnostics | [12192220] |
| 5 | cDNA Sequencing | [12192225] |

FIG. 7 illustrates a system for matching a searcher's attributes profile 16 against requirements profiles 20. The system 50 includes a server 12 providing a user interface 52 for entering planners' requirements profile 20, including the weight of each requirement collectively known as weighting factors 22 to indicate the importance of the requirements to the planners. Server 12 also provides a user interface 56 for entering a searcher's attributes profile 16. A coding module 24 associates a numeric code with each attribute and requirement. In one embodiment, a requirements data structure 28 contains the numeric codes representing the planners' requirements profiles 20. In another embodiment, an attributes data structure 26 contains the numeric codes representing the searcher's attributes profile 16. A data query engine 30 compares the searcher's attributes profile 16 against the planners' requirements profiles 20 and provides a search result 32, that is, a list of planners that have requirements that relate to the searcher's attributes. A ranking module 34 provides ranked results 36, which rank the planners based on the degree of match between each of the planner's requirements profile and the searcher's attributes profile.

FIG. 7 also shows that server 12 provides an interface 52 to enable each planner to enter a list of credentials 54. The server 12 writes the lists of credentials 54 in a credentials data structure 40. The server 12 also provides an interface 42 to enable a validator to review the lists of credentials 54 and submit an assessment 44 to the credentials data structure 40. The server 12 also provides search results presentation 58 to the searcher, including the ranked results 36 and the credentials summaries 46.

One embodiment of the present invention is a method and system, used on a Web site, by which sellers of engineering and related services indicate their skills, know-how, offerings, and searchers indicate their requirements, preferably using the linked-menus described earlier and provided by the site. The site members' current attributes are stored in the site's attributes data structure 26 as shown in FIG. 1. The searchers' currently active procurement-package(s) are tabulated in the requirements data structure 28 as shown in FIG. 1. By using numeric codes rather than keywords and phrases during the searching and matching process, the search is independent of the user's language. The user does not need to see the numeric codes, only the text equivalents, in his or her language.

In that embodiment, matching resources with opportunities is accomplished in the searching process via a compilation of a “weighted average percent match” between the numeric codes specified in a procurement-package and the numeric codes characterizing each services candidate, as stored in the site's attributes data structure.

A label is the text equivalent of a numeric code, expressed in the language of the user. The coding module 24, as shown in FIGS. 1 and 7, uses tables that provide a one-to-one association between a numeric code and the label. The tables exist, on the web site, in various languages to accommodate different user languages. The same concept, regardless of language, has the same numeric code. The menus seen by a site user, in his/her language, have been extracted from the tables (the associated numeric codes can be hidden from the user's view).

An inverted-index is preferably used to facilitate efficient manipulation of the attributes data structure 26 and the requirements data structure 28. The inverted-index identifies for each numeric code beginning with a particular L1 L2 combination, the candidates or planners who have registered codes beginning with that L1 L2 combination. This enables rapid identification of those candidates who will have profiles containing codes beginning with that L1 L2 combination. All other candidates or planners can be safely ignored.

The ranking module 34 determines the degree of relevance between a target numeric code and a candidate numeric code using the relevance values in the hierarchy. The relevance of a compound code (where one term is associated with another) is the product of the individual relevance values.

A user can assign the importance of each requirement in evaluating candidates. For example, in one embodiment the user can indicate whether the requirement is something the candidate must have, should have, or would be good to have. These importance terms can be assigned weights, such as:

| Importance | Weight |
|---|---|
| Must have | 1 |
| Should have | ½ |
| Good to have | ⅓ |

In one embodiment, the overall match is the weighted average of the relevance values, shown in FIG. 6 such as the 55% value associated with genomic sequencing when targeting cDNA sequencing, for each numeric code in the requirements profile and each numeric code in the attributes profile. The results of a search are ranked in order of overall match. In one embodiment, overall match is calculated by the following formula:

Overall match=sum of (weight ᵢ×relevance value ᵢ)/sum of (weight ᵢ)

Consequently, one preferred embodiment of the present invention relates to a classification/search technology that operates in concept-space rather than lexicon-space. That is, concepts (expressed in words and phrases) are arranged in a classification/search hierarchy and guide the matching process.

The present invention can be used for classifying and searching any knowledge, skills, know-how, services, materials, equipment, information or other data where the matching of attributes and/or requirements is useful to an entity, such as a person, organization or institution (e.g., business, industry, government, education). It also provides for associating one attribute or requirement with another thus enabling an almost unlimited classification scheme with relatively few pre-defined entries.

As described in the preferred embodiment, the attributes and requirements profiles are saved in an attributes data structure or a requirements data structure, respectively. One of ordinary skill would understand that ad hoc searches could be conducted as well, and the profiles not saved in either or both of the data structures.

What is claimed:

1. A computer-implemented method of characterizing attributes of a candidate, in data that is independent of language, comprising:
providing an interface to enable a user to describe attributes by selecting from an hierarchical structure;
associating a numeric code with each attribute; and
arranging the numeric code for each attribute selected by the user in an attributes profile, and repeating the above steps for other candidates.

2. The method of claim 1, wherein the attributes include skill, know-how, properties, characteristics, and/or services.

3. The method of claim 1, wherein the interface enables the user to list credentials.

4. The method of claim 1, wherein hierarchical structure is presented as a set of linked menus or lineage strings.

5. The method of claim 3, further comprising providing an interface to enable a validating party to access the candidate's credentials, and recording the validating party's assessment of the credentials.

6. A computer-implemented method of characterizing a searcher's requirements in terms of the candidate's attributes, comprising:
providing an interface to enable the searcher to select and specify the importance of each attribute;
associating a numeric code with each attribute; and
recording the numeric code and associated importance for each attribute selected by the searcher, building a requirements profile.

7. A system, comprising:
(a) a server providing a user interface for entering candidates' attributes profiles;
(b) a server providing a user interface for entering a searcher's requirements profile, including the importance of each requirement;
(c) a coding module to associate a numeric code with each attribute and requirement;
(d) numeric codes representing the candidates' attributes profiles;
(e) numeric codes representing the searcher's requirements profile;
(f) a data query engine to compare the searcher's requirements profile against the candidates' attributes profiles and to provide a list of candidates that have attributes that relate to the searcher's requirements; and
(g) a ranking module to rank the list of candidates based on the degree of match between each candidate's attributes profile and the searcher's requirements profile.

8. The system of claim 7, further comprising:
a server providing an interface to enable candidates to enter lists of credentials;
a credentials data structure containing the lists of credentials; and
a server providing an interface to enable a validator to access and review candidates' lists of credentials and submit a review of the lists of credentials into the credentials data structure.

9. The system of claim 7, wherein the degree of match is determined by the weight of each requirement and the position of the requirement relative to the nearest matching attribute in a hierarchy of attributes.

10. The system of claim 7, wherein the structure of the numeric codes defines a hierarchy of related attributes and/or requirements, and their relationship is represented by the assigned relevance values to each position in the hierarchy.

11. A computer-implemented method of characterizing a planner's requirements in terms of the candidate's attributes, in data that is independent of language, comprising:
providing an interface to enable the planner to describe their requirements by selecting from an hierarchical structure and specify the importance of each requirement;
associating a numeric code with each requirement; and
arranging the numeric code for each requirement and associated importance for each requirement selected by the planner in a requirements profile, and repeating the above steps for other planners.

12. The method of claim 11, wherein the planner's requirements include skill, know-how, properties, characteristics, and/or services.

13. The method of claim 11, wherein the interface enables the planner to list credentials.

14. The method of claim 13, further comprising:
providing an interface to enable a validating party to access the credentials, and recording the validating party's assessment of the credentials.

15. A computer-implemented method of characterizing a searcher's attributes, comprising:
providing an interface to enable the searcher to select each attribute;
associating a numeric code with each attribute; and
recording the numeric code for each attribute selected by the searcher, building an attributes profile.

16. A system, comprising:
(a) a server providing a user interface for entering planners' requirements profiles including the importance of each requirement;
(b) a server providing a user interface for entering a searcher's attributes profile;
(c) a coding module to associate a numeric code with each attribute and requirement;
(d) numeric codes representing the planners' requirements profiles;
(e) numeric codes representing the searcher's attributes profile;
(f) a data query engine to compare the searcher's attributes profile against each planner's requirements profile and to provide a list of planners that have requirements that relate to the searcher's attributes; and
(g) a ranking module to rank the list of planners based on the degree of match between each planner's requirements profile and the searcher's attributes profile.

17. The system of claim 16, further comprising:
a server providing an interface to enable the planners to enter lists of credentials;
a credentials data structure containing the lists of credentials;
a server providing an interface to enable a validator to access and review the planners' lists of credentials and submit a review of the lists of credentials into the credentials data structure.

18. The system of claim 16, wherein the degree of match is determined by the weight of each requirement and the position of the requirement relative to the nearest matching attribute in a hierarchy of attributes.

19. The system of claim 16, wherein the structure of the numeric codes defines a hierarchy of related attributes and/or requirements, and their relationship is represented by the assigned relevance values to each position in the hierarchy.

20. The system of claim 16, wherein the hierarchical structure conveys the relationship between attributes and a requirement.
